(19) United States
(12) Patent Application Publication
(10) Pub. No.: US 2005/0283377 A1
(43) Pub. Date: Dec. 22, 2005

(54) Evaluation information generating system, evaluation information generating method, and program product of the same

(75) Inventors: Tohru Nagano, Yokohama-shi (JP); Hideo Watanabe, Tokyo-to (JP)

Correspondence Address: RICHARD M. GOLDMAN, 371 ELAN VILLAGE LANE, SUITE 208, CA, 95134, US

(73) Assignee: International Business Machines Corporation

(21) Appl. No.: 11/150,039

(22) Filed: Jun. 10, 2005

(30) Foreign Application Priority Data
Jun. 16, 2004 (JP) 2004-178628

(51) Int. Cl. G06F 17/60

(52) U.S. Cl. 705/1

(57) ABSTRACT

To enable a competitor analysis using reputation analysis. A system includes: inputting means for inputting a reputation data set which is composed of reputation data, each indicating a degree of reputation regarding a specific subject, and which can be divided into a plurality of categories; reputation data storing means for storing the inputted reputation data set; counting means for counting an occurrence frequency of reputation data having a predetermined degree of reputation among the reputation data constituting the reputation data set, for each category of the stored reputation data set; counting result storing means for storing results of counting; extracting means for extracting necessary information from the stored results of counting; extraction result storing means for storing results of extraction; generating means for generating evaluation information on the specific subject while reflecting the results of counting for the respective extracted categories; and outputting means for outputting the evaluation information.

### BACKGROUND OF THE INVENTION

1. Field of the Invention

The present invention relates to an evaluation information generating system which generates evaluation information on a subject of evaluation, by analyzing text data including an expression regarding reputation.

2. Background Art

In recent years, a technology named as a “reputation analysis” is getting much attention as a subject for applications in areas such as a questionnaire, and a bulletin board in the Internet (for example, refer to non-patent literature 1, and non-patent literature 2). The reputation analysis makes capture of user's intentions possible by extracting expressions regarding reputation from texts described in a questionnaire and bulletin board. For example, it is possible for a company to make product development on the basis of opinions of users, and to prevent a spread of some rumors by use of reputation analysis regarding a questionnaire, and a bulletin board in relation to the company's own products.

Hitherto, malfunctions and dissatisfaction of a product, and the like reach directly to a company's customer service. However, in these days anybody can use the Internet, and under the circumstances it can be easily understood that there are various opinions expressed regarding products of a company in many cases in which, on the contrary, the company cannot reach the opinions easily. Therefore, the company needs to acquire some tools: to widely gather the opinions from many sources; to correct some erroneous information; and to appropriately respond to the reputations.

Meanwhile, an important aspect in performing the reputation analysis described hereinbefore resides in how useful information can be extracted out of a large amount of gathered opinions. For example, a company should not merely devote itself analyzing opinions toward it. Rather, it is important for the company to analyze reputations, that is, what would be the opinions toward its own company from other companies. In other words, it is important for the reputation analysis toward the own products to be performed on the basis of comparison with products that belong to the same category of other companies.

However, in Satoshi Morinaga, Kenji Yamanishi, Kenji Tateishi, Toshikazu Fukushima, “Mining Product Reputations on the Web”, ACM KDD-2002, 2002, and Kenji Yamanishi, “Web mining and information-based induction sciences—reputation analysis and abnormal log detection—”, workshop on information-based induction sciences 2002, an analysis (competitor analysis) which takes into account a relationship with other companies, which is in competition with its own company, is not conducted. What is performed is a search of reputations on any of its own products from the Internet by matching input texts with previously prepared patterns. For mobile gear, for example, it is merely a search of reputations which include “the mobile gear is good.”

### SUMMARY OF THE INVENTION

The present invention is made to give solutions to the forgoing technical problems, and an object thereof is to make a competitor analysis possible by using the method of reputation analysis.

Another object of the present invention is to make it possible to analyze reputations toward its own company raised by other companies.

Still another object of the present invention is to make it possible to analyze reputation toward its own product on the basis of comparison thereof to that of a product in the same category from another company.

With the objects described hereinbefore, the present invention performs identification of characteristic items in comparison with other items by referencing them to the patterns indicating “good_reputation” and “bad_reputation”, after counting expressions regarding reputations from the texts for each keyword (item). In other words, the evaluation information generating system includes the followings: inputting means for inputting a reputation data set which is composed of reputation data, each indicating a degree of reputation regarding a specific subject, and which can be divided into a plurality of categories; counting means for counting an occurrence frequency of reputation data having a predetermined degree of reputation among the reputation data constituting the reputation data set, for each category of the reputation data set inputted by the input means; and generating means for generating evaluation information on the specific subject by reflecting results of counting attained for the respective categories by the counting means.

The analysis performed in this evaluation information generating system constitutes of an analysis 1 and 2. In the analysis 1, “good”/“bad” reputations from other companies, are counted for each company. In this process, companies that have good reputations and that does not are extracted. In this case, the company which is given “good”/“bad” reputations from other companies is regarded as a “specific subject”, and each company expresses opinions about “good”/“bad” reputations toward other companies is regarded as a “category”.

Moreover, in the analysis 1, “positive”/“negative” opinions toward the other companies are also counted for each company. By doing so, companies that have a certain level of interest toward other companies and that does not are separately extracted. In this case, the company which expresses “positive”/“negative” opinions toward other companies is regarded as a “specific subject”, and each company receives opinions about “good”/“bad” reputations from other companies is regarded as a “category”.

Meanwhile, in the analysis 2, comparison is made on each product between companies, and superior aspects and inferior aspects are separately extracted. In this case, a product, such as a “memory” and a “hard disk”, is regarded as a “specific subject”, and each company that produces the respective product is regarded as a “category”.

Moreover, the present invention can be regarded as a method which generates evaluation information. The method includes the steps of: by using the computer, inputting a reputation data set which is composed of reputation data, each indicating a degree of reputation regarding the specific subject, and which can be divided into a plurality of categories; by using the computer, counting, for each category of the reputation data set, an occurrence frequency of reputation data having a predetermined degree of reputation among the reputation data constituting the reputation data set, and storing results of counting for the respective categories in a storage device; and by using the computer, reading the results of counting for the respective categories from the storage device, and generating evaluation information on the specific subject by reflecting the results of counting for the respective categories.

Meanwhile, the present invention can be regarded as a program product which causes a computer to realize pre-determined functions. In this case, the program implements the following functions: a function of inputting a reputation data set which is composed of reputation data, each indicating a degree of reputation regarding a specific subject, and which can be divided into a plurality of categories; a function of counting an occurrence frequency of reputation data having a predetermined degree of reputation among the reputation data constituting the reputation data set, for each category of the reputation data set; and a function of generating evaluation information on the specific subject while reflecting results of counting for the respective categories.

According to the present invention, a competitor analysis using a reputation analysis is made possible.

### BRIEF DESCRIPTION OF THE DRAWINGS

For a more complete understanding of the present invention and the advantages thereof, reference is now made to the following description taken in conjunction with the accompanying drawings.

FIG. 1 is a block diagram showing an entire configuration of an embodiment of the present invention.

FIG. 2 is a block diagram showing a hardware configuration of an evaluation information generating system in the embodiments of the present invention.

FIG. 3 is a diagram showing a functional constitution of the evaluation information generating system in the embodiments of the present invention.

FIG. 4 is a flowchart showing a series of operations in analysis 1 in the evaluation information generating system of the embodiments of the present invention.

FIG. 5 is a table showing an occurrence frequency of “good_reputation” and “bad_reputation” regarding reputation data in use of analysis 1 in the evaluation information generating system of the embodiments of the present invention.

FIG. 6 is a table showing an example of counting result to be stored in the analysis 1 in the evaluation information generating system of the embodiments of the present invention.

FIG. 7 is a diagram showing second reputation information generated in the analysis 1 in the evaluation information generating system of the embodiments of the present invention.

FIG. 8 is a flowchart showing a series of operations in analysis 2 in the evaluation information generating system of the embodiments of the present invention.

FIG. 9 is a table showing an occurrence frequency for “good_reputation” and “bad_reputation” regarding reputation data in use of the analysis 2 in the evaluation information generating system of the embodiments of the present invention.

FIG. 10 is a diagram describing ranks defined in the analysis 2 in the evaluation information generating system of the embodiments of the present invention.

FIG. 11 is a diagram showing third reputation information generated in the analysis 2 in the evaluation information generating system of the embodiments of the present invention.

### DETAILED DESCRIPTION OF THE PREFERRED EMBODIMENTS

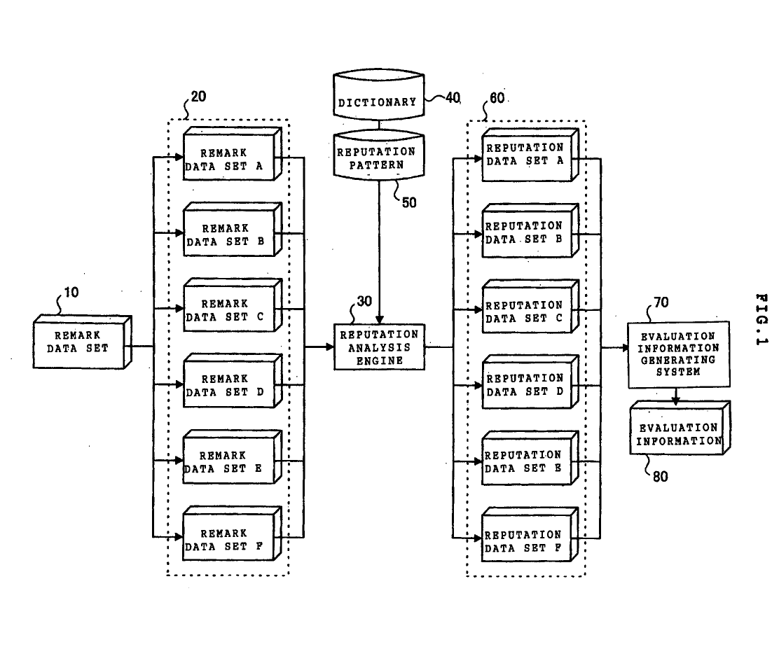

Thereinafter, a preferred embodiment (hereinafter referred to as “an embodiment”) of the present invention will be described in detail with reference to the accompanying drawings. FIG. 1 is a block diagram showing entire processes of the embodiment. In the embodiment, first, a remark data set 10 constituted of remark data corresponding to each remark which is described in a questionnaire, a bulletin board in the Internet and the like, separated into remark data sets A to F. The remark data sets A to F are elements of a group 20 of remark data sets.

The separation, such as this as described hereinbefore, can be made by directly adopting the pre-defined separation criterion in the remark data set 10, or can be automatically performed by using a conventional technology based on the analysis of remark data set 10. The separation method used in this embodiment is described by use of a bulletin board on PC (Personal Computer) as an example. First, the former separation method is a method which adopts, as each remark data set, a set of remark data described in each bulletin board, where the bulletin boards are separated and designated to each PC manufacture. The latter separation method is a method automatically separating the remark data set 10, as each remark data set, on the basis of information and the like supplied from a person who gives his/her remark, the bulletin board is not separated for each PC manufacture.

It should be noted that in the embodiment it is assumed there are six remark data sets, that is, remark data set A to F, included in the group 20 of remark data sets, but the count of the data sets is not intended to be limited to six.

Next, a reputation analysis engine 30 having inputted remark data sets A to F performs reputation analysis on the basis of Dictionary 40 and reputation pattern 50, and outputs reputation data sets A to F which are elements of a group of reputation data sets. In other words, the reputation analysis engine 30 analyzes remark data which is included in each remark data set, and outputs the information obtained in the analysis to respective reputation data set. For example, the information obtained by analyzing the remark data set A will be outputted as a reputation data set A, and the information obtained by analyzing the remark data set B will be outputted as a reputation data set B.

Here, an operation of the reputation analysis engine 30 is specifically described.

The reputation analysis engine 30 performs a morphological analysis and dependency analysis regarding the texts included in each remark data set, and generates a syntactic tree. Thereafter, the reputation analysis engine 30 attaches labels to subtrees in the syntax tree by referring to reputation patters 50. For example, if a pattern, that is, “(The price is high.)=>bad_reputation”, is registered in the reputation pattern 50, a “bad_reputation” label will be attached to a text including the remark that “The price of product X is high”.

Moreover, in the case of labeling in reference to the reputation pattern 50, Dictionary 40 is also referred. For example, if synonyms of “price”, such as “cost” and “retail price” are registered in Dictionary 40, a “bad_reputation” label will be attached not only to a text including the remark that “The price is high.” but also those including the remarks that “The cost is high.” and “The retail price is high.”.

Next, the reputation analysis engine 30 extracts (subject of reputation) which subject the reputation expressions in each remark data set are made to. For example, regarding the remark that “The price of product X is low. The quality of product Y is poor”, the good_reputation, that is, “The price is low.” is related to “product X”, and the bad_reputation, that is, “The quality is poor.” is related to “product Y”. This subject of reputation is extracted on the basis of clues described hereinafter.

First, if there is a remark “The price of product X is lower.” written in an input text, a subject of reputation becomes the “product X” which is a word having dependency to the structure of “The price is low”, by using a result of a dependency analysis.

Secondly, if there is a label of “product X” attached in the input text, the label is to be used. For example, in the case of a questionnaire that “What do you think about the product X?”, it is not often a case to have a reply stating that “The price of product X is low.”, but mostly it is the case to have a reply stating that “The price is low.”. Here, a subject of the reputation, that is, “The price is low.” is the “product X”.

When there are no clues which are described above, a series of words which is in an advanced position regarding the interested reputation expression is searched, and a noun or a proper noun which will appear first is designated as the subject of reputation.

Moreover, within the actual reputation expressions, in some cases, a plurality of keywords are included in a part of the text recognized as a subject of reputation. For example, in the case that “A hard disk of B Company is noisy.”, a part that is recognized as a subject of reputation is “a hard disk of B Company”. However there are two key words are involved in that, and those are “B Company” and “a hard disk”. Under this circumstance, the present embodiment separately extracts “B Company” as a name of the company and “a hard disk” as a name of the product.

Compared to this, for example, in the case of text that “The picture screen is bright.”, a company name is not extracted but only “the picture screen” is extracted as a subject of reputation.

Meanwhile, the present embodiment is intended to extract a keyword representing a name of a company and a keyword related to a product as a subject of reputation. However, as to keywords related to a product, subjects which are not in the category of a product, such as “picture screen” and “design” are thought to be included. However to make the description simple, if “product” is quoted in this specification, not only “a product” itself but also keywords which are not strictly in the category of “product” are intended to be included.

Moreover, extraction of names of a company and a product, for example, is made possible by matching them with names of companies and products stored in Dictionary 40.

Next, contents in reputation data which is included in each reputation data set and which is outputted as has been described are explained.

First, in the group 60 of reputation data sets, information to identify each reputation data set is attached to each reputation data set as “base”. For example, in the case that a remark data set A is a remark data set constituted of remark data of a user of a product by Company A (a remark data set by a user of Company A), the “base” of the reputation data set A generated in this case is “Company A”.

Moreover, among subjects of reputation acquired by analyzing each reputation data set, a name of a company is set as “subject”, and a name of a product is set as “feature”. Further, reputation labels attached to each remark data, such as good_reputation/bad_reputation are set as “label” and more specific reputation expressions are set as “reputation”.

A reputation data having information, such as “base”, “subject”, “feature”, “label” and “reputation”, is designated as “frg(base, subj, feat, label, rep)” hereinafter. Note that “subj”, “feat” and “rep” are abbreviations of “subject”, “feature” and “reputation” respectively, when the designated representation is utilized.

For example, texts namely “The price of product X is low. The quality of product Y is poor.” in a remark data set by a user of Company A, two kinds of reputation data set are obtained. Those are,

frg(“Company A”, “Company A”, “product X”, “good_reputation”, “price is low”)

frg(“Company A”, “Company A”, “product Y”, “bad_reputation”, “quality is poor”)

In this case, though the text does not include a company name, “Company A” is set in “subject”. Since the text is concerned with a remark data set by a user of Company A and does not include any indication of a name of another company, it is possible to consider that the reputation raised therein is for a product of Company A.

Moreover, in the same way, from “The price of Company B is lower. The specification of Company C is better.” in a remark data set by a user of Company A, two kinds of reputation data set are obtained. Those are,

frg(“Company A”, “Company B”, “good_reputation”, “price is low”)

frg(“Company A”, “Company C”, “good_reputation”, “specification is better”).

In this case, since the text does not contain the name of a product, no data is set in “feature.” This indicates reputation directed to another company.

After the acquisition of reputation data, an evaluation information generating system 70 performs analysis on reputation data set constituting of a set of reputation data, generates evaluation information 80, and outputs the evaluation information 80.

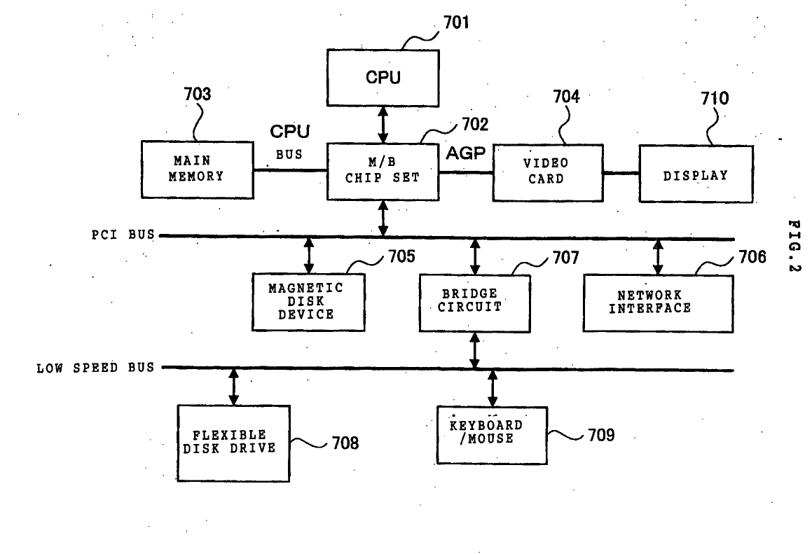

FIG. 2 is a schematic view showing an example of a preferred hardware configuration of a computer used as an evaluation information generating system 70 in the embodiment.

A computer shown in FIG. 2 is configured of, a CPU (Central Processing Unit) 701 which is computational means, a main memory 703 which is connected to the CPU 701 via an M/B (Mother Board) chip set 702 and CPU bus, a video card 704 and display 710 which are connected to the CPU 701 via the M/B chip set 702 and AGP (Accelerated Graphics Port), a magnetic disk device (HDD) 705 which is connected to the M/B chip set 702 via a PCI (Peripheral Component Interconnect), a network interface 706, and a flexible disk drive 708 and a keyboard/mouse 709 which are connected to the M/B chip set 702 via a low speed bus such as a bridge circuit 707 and ISA (Industry Standard Architecture) bus from the PCI bus.

It should be noted that FIG. 2 only exemplifies a hardware configuration of a computer which can realize the present embodiment. Any sorts of various configurations can be adopted if the present embodiment is configurable. For example, instead of configuring with the video card 704, a configuration equipped with only a video memory and causing the CPU 701 to process an image data is also possible. As to an external memory device it is also possible to install a CD-R (Compact Disc Recordable) and DVD-RAM (Digital Versatile Disc Random Access Memory) via an interface such as ATA (AT Attachment) and SCSI (Small Computer System Interface).

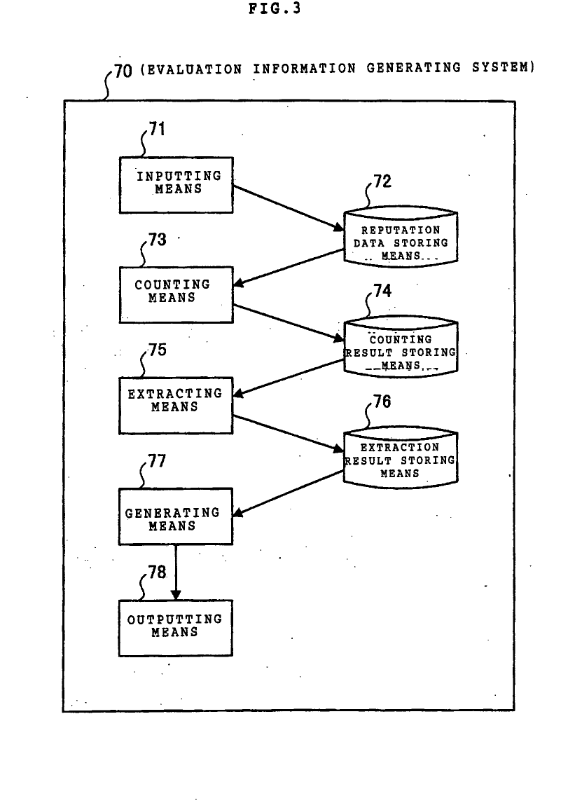

FIG. 3 shows a functional configuration of the evaluation information generating system 70.

As shown in FIG. 3, the evaluation information generating system 70 is constituted of input means 71, reputation data storing means 72, counting means 73, counting result storing means 74, extracting means 75, extraction result storing means 76, generating means 77, and outputting means 78.

Here, the input means 71 is means for inputting each reputation data included in the reputation data set. The reputation data storing means 72 is means for storing each inputted reputation data. Moreover, the counting means 73 is means for counting reputation data stored in the reputation data storing means 72 in accordance with a pre-determined rule. The counting result storing means 74 is means for storing this counting result. Furthermore, extracting means 75 is means for extracting information from the counting result stored in counting result storing means 74 in accordance with a pre-determined reference. The extraction result storing means 76 is means for storing this extracted result. Still further, generating means 77 is means for generating evaluation information 80 on the basis of the extracted results stored in the extraction result storing means 76. The outputting means 78 is means for outputting this evaluation information 80.

Next, operations of the evaluation information generating system 70 are described.

In the evaluation information generating system 70, first, the input means 71 inputs each reputation data included in the reputation data set to the reputation data storing means 72, and each reputation data is stored in the storing means 72. Thereafter, the counting means 73, extracting means 75, and generating means 77 execute analysis 1 or 2 described hereinafter. Alternatively, after executing the analysis 1, it is possible to investigate the result of the analysis further in depth in the analysis 2.

(Analysis 1)

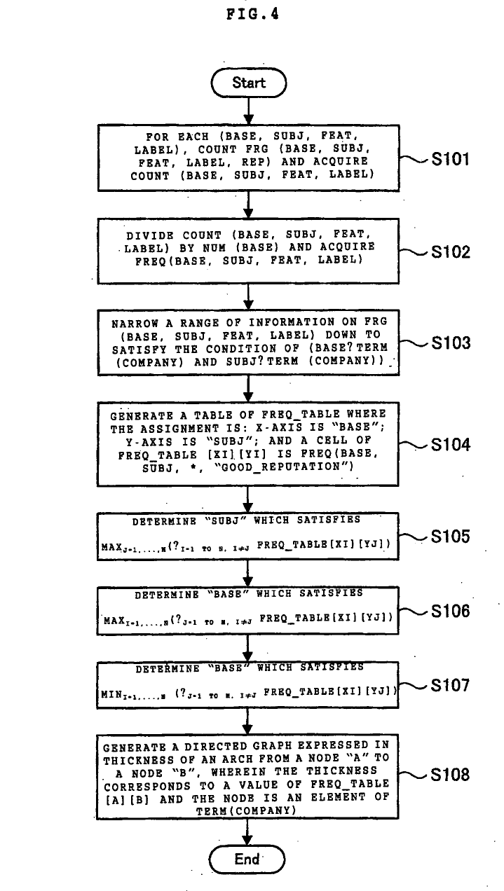

FIG. 4 is a flowchart showing processing operations in the counting means 73, extracting means 75, and generating means 77 in the analysis 1.

First, the counting means 73 performs counting of a number of reputation data “frg(base, subj, feat, label, rep)” for each combination of “base”, “subject”, “feature”, and “label”, and acquires an occurrence frequency “count(base, subj, feat, label)” (Step S101). For example, as for the reputation data in which “base” is “Company A”, “subject” is “Company B” and “feature” is “hard disk”, the processing is performed to acquire counts for both “good_reputation” and “bad_reputation” for each “label”.

While, the counting means 73 acquires a relative occurrence frequency “freq(base, subj, feat, label)” by dividing the occurrence frequency “count(base, subj, feat, label)” with “NUM(base)” (Step S102). Note that a “NUM(base)” is a total count of reputation data having the same “base”. For example, the occurrence frequency of the reputation data in which “base” is “Company A”; “subject” is “Company B”; “feature” is “hard disk” and “label” is “good_reputation”; is divided by the total count of the reputation data so as to acquire the relative occurrence frequency.

Next, the extracting means 75 extracts reputation data to be used in the analysis. The analysis is to analyze which company and/or which product users or potential users of a product of each company are interested in. Therefore, what is extracted is reputation data of the users of a product produced by a company which is targeted to be analyzed. The extraction is conducted for the product which is the subject of reputation produced by the company which is to be analyzed.

Specifically, first a definition is made for a set “term (Company)” whose element is a company as a subject of analysis. Here the elements defined are “Company A”, “Company B”, “Company C”, “Company D”, “Company E”, and “Company F”. The extracting means 75 focuses on reputation data on companies which are set for a “base” and a “subject” simultaneously. Here, both of them are elements of a “term(Company)”. Then, the extracting means 75 extracts information relating to the reputation data (step S103).

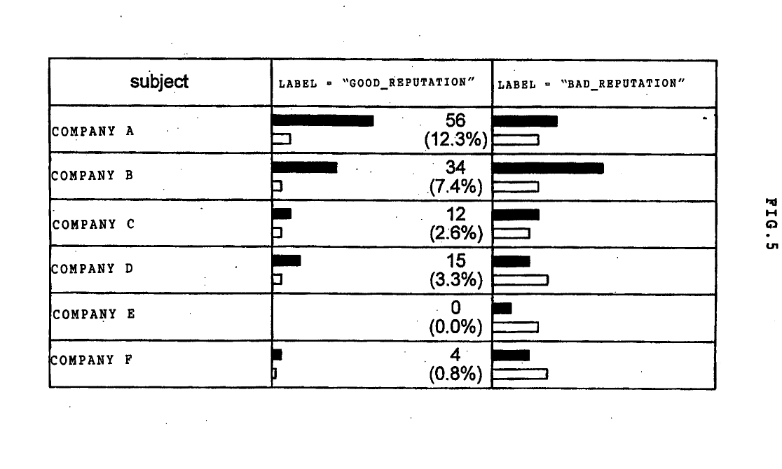

FIG. 5 is a graph showing occurrence frequency and relative occurrence frequency for respective “label”s of “good_reputation” and “bad_reptation” regarding each “subject” for reputation data the “base” of which is “Company A”. Note that in each frame a black bar in the graph show an occurrence frequency, and a white bar in the graph show a relative occurrence frequency.

Thereafter, the generating means 77 performs mapping of occurrence frequency and relative occurrence frequency for each “base” and “subject” in a two dimensional table which is set for each “label” (step S104).

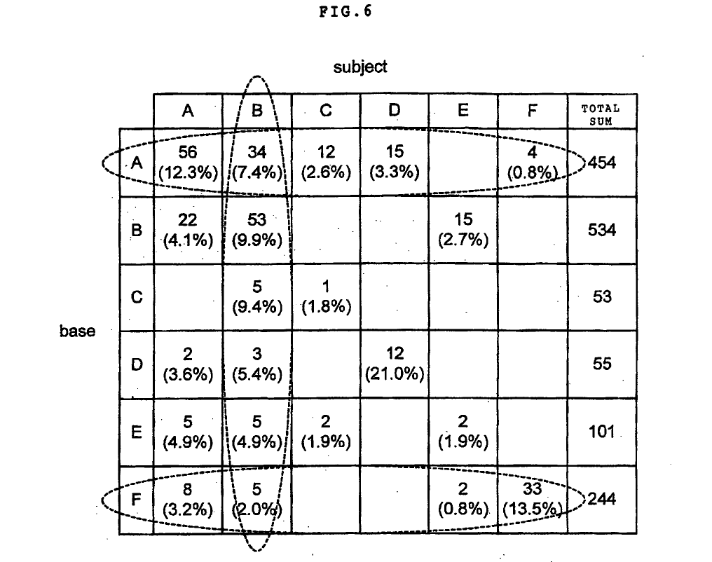

FIG. 6 shows a two dimensional table generated for reputation data in which “label” indicates “good_reputation”. By use of occurrence frequency of reputation data in which the “label” indicates “good_reputation”, it is possible to count reputation data which can be classified as being in favor in contrast to other companies. This will be different from a mere counting using occurrence frequency based only on company names.

In this two dimensional table, a longitudinal direction is set as a X-axis, and a lateral direction is set as a Y-axis. Thereafter, “base” is assigned to the X-axis, and “subject” is assigned to the Y-axis. Moreover, in a cell for freq_table[xi][yj], where “base” is “xi” and “subject” is “yj”, the occurrence frequency, “count(base, subj, *, “good_reputation”)”, is described in the upper row, and the relative occurrence frequency, “freq(base, subj, *, “good_reputation”)”, is set in the lower row. Note that the symbol, “*”, shows “feature” can be any value. In other words, “freq(base, subj, *, “good_reputation”)” can be reputation data regarding a specific product of a company indicated by the “subject” or can be reputation data regarding a company itself indicated in the “subject”.

Note that the occurrence frequency and relative occurrence frequency in which the “label” in FIG. 5 is “good_reputation” are set in the row where a “base” is “Company A” in FIG. 6.

Next, in the analysis, comparison with other competitor companies will be conducted from a standpoint set forth hereinafter. Specifically, a company corresponding to each reference criterion is identified on the basis of relative occurrence frequency of each cell in this two dimensional table, and thus, a first evaluation information is obtained.
(1) A company which receives a largest count of “good_reputation”s from other companies.

This is a company which receives the most favorable reputations from users of products by other companies. The company which fits in this reference criterion is considered to be the most excellent company. Specifically, this company is the one which has the largest sum of relative occurrence frequency of each cell in the longitudinal direction. However, the relative occurrence frequency which has the same company for each “base” and “subject” is not added in calculation of the total sum.
(2) A company which provides a largest count of “good_reputation”s to other companies.

This is a company which holds a large percentage of users who are interested in products of other companies. The company fitted in this reference criterion is considered to be a company which holds a large number of users who are likely to secede. It seems that it is necessary to apply some measures for this sort of company. Specifically, this company is classified as a company which has a largest sum of relative occurrence frequency of each cell in the lateral direction among the companies set in the “base”. However, the relative occurrence frequency which has the same company for each “subject” and “base” is not added in calculation of the total sum.
(3) A company which does not provide a largest count of “good_reputation”s to other companies.

This is a company which holds users who are not conscious of products of other companies. In other words, this is a company which holds a unique feature. Specifically, this company is classified as a company which has the smallest sum of relative occurrence frequency of each cell in the lateral direction among the companies set in the “base”. However, the relative occurrence frequency which has the same company for each “subject” and “base” is not added in calculation of the total sum.

This will be specifically observed along the flowchart in FIG. 4. First, the “subject” classified in the reference criterion in (1) above is determined (step S105). In an example in FIG. 6, a total sum of relative occurrence frequency for the case that “subject” is “Company B” is the maximum having “29.1(=7.4+9.4+5.4+4.9+2.0)”. Thus, “Company B” is classified as a company stated in (1).

Moreover, the “base” classified in the reference criterion in (2) above is determined (step S106). In an example in FIG. 6, a total sum of relative occurrence frequency for the case that the “base” is “Company A” is the maximum having “14.1(=7.4+2.6+3.3+0+0.8)”. Thus, “Company A” is classified as a company stated in (2).

Further, the “base” classified in the reference criterion in (3) above is determined (step S107). In an example in FIG. 6, a total sum of relative occurrence frequency for the case that the “base” is “Company F” is the minimum having “6.0(=3.2+2.0+0+0+0.8)”. Thus, “Company F” is classified as a company stated in (3).

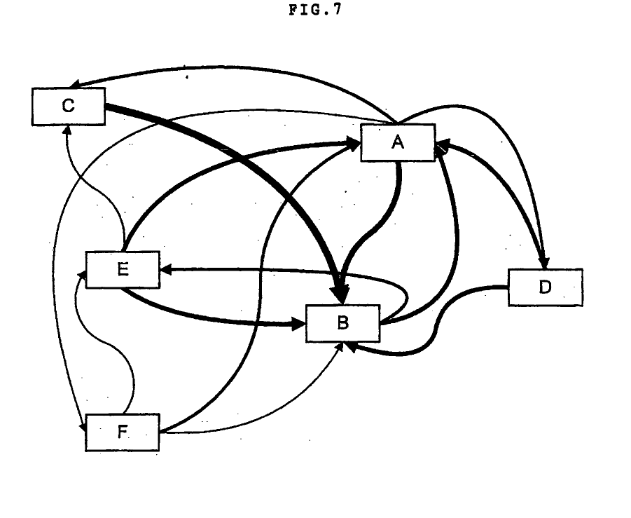

On the other hand, the generating means 77 generates a directed graph shown in FIG. 7 as a second evaluation information (step S108). In this directed graph, each company is indicated as a node. The fact that which company has stated a positive opinion to which company is expressed as an arch which connects each node. Note that an arch is directed from a company which states a positive opinion to another company which receives the positive opinion therefrom. Moreover, the thickness of the arches represents relative occurrence frequency regarding the negative opinions.

By conducting analysis described hereinbefore, for example, assuming that it has been found that a PC user of manufacturer A is interested in a PC made by manufacturer B, then manufacturer A takes measures to retain the user by analyzing drawback points of the product of the company. Meanwhile, the manufacturer B can conduct efficient marketing through an intensive sales activity toward users of manufacturer A.

It is to be noted that in the foregoing operations it is assumed that both the first and second evaluation information is generated. However generation of either one of the two is also possible.

Moreover, as for the first evaluation information, it is not necessarily limited to information indicating classified companies in the reference criterion of (1), (2), and (3) described above. For example, it is acceptable to set other reference criterions other than these. Besides, it is also acceptable to show arrangement of companies that are to be the subjects of analysis in order in accordance with a reference to the pre-determined reference criterion.

Further, the second evaluation information is to show a relationship between those quote and those quoted for all the companies which are subjects of analysis. However it is also acceptable to show a relationship between those quote and those quoted for several of the companies which are the subjects of analysis.

Further hereinbefore, a description is given for the case that the first and second evaluation information is generated when the “label” is “good_reputation”. However, when the “label” is “bad_reputation”, it is also possible to generate the first and second evaluation information.

(Analysis 2)

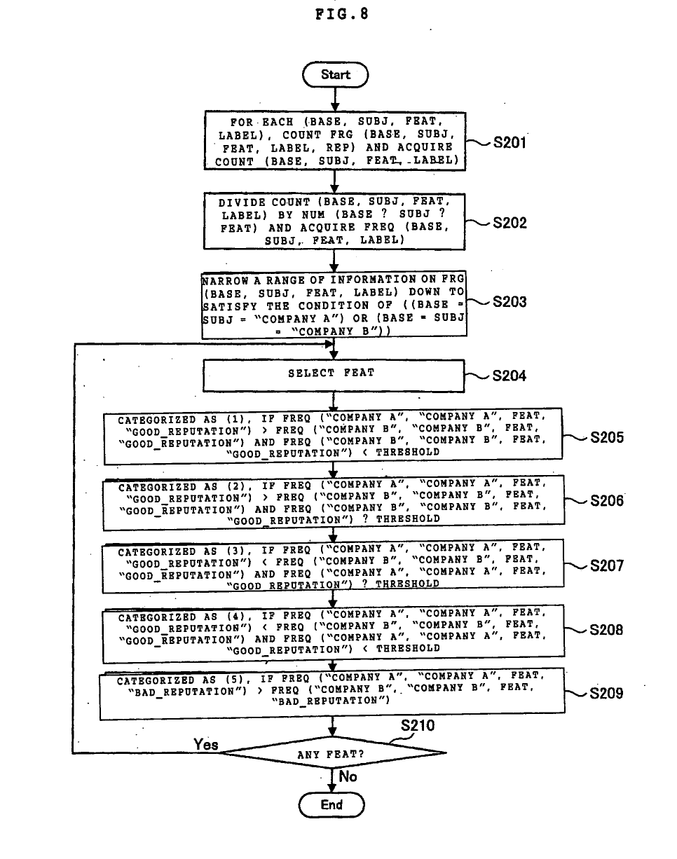

FIG. 8 is a flowchart showing processing operations in the counting means 73, extracting means 75, and generating means 77 in the analysis 2.

First, the counting means 73 performs counting of a number of reputation data “frg(base, subj, feat, label, rep)” for each combination of “base”, “subject”, “feature”, and “label”, and acquires an occurrence frequency “count(base, subj, feat, label)” (Step S201). For example, as for the reputation data in which the “base” is “Company A”, the “subject” is “Company B” and the “feature” is “hard disk”, the processing is to be performed to acquire both counts for “good_reputation” and “bad_reputation” in terms of “label”.

While, the counting means 73 acquires a relative occurrence frequency “freq(base, subj, feat, label)” by dividing the occurrence frequency “count(base, subj, feat, label)” with a “NUM(base and subj and feat)” (Step S202). Note that a “NUM(base and subj and feat)” is a total count of reputation data having the same “base”, “subject” and “feature”. For example, the occurrence frequency of the reputation data in which the “base” is “Company A”; the “subject” is “Company A”; the “feature” is “hard disk”; and the “label” is “good_reputation”; is divided by the total count of the reputation data where the “base” is “Company A”; the “subject” is “Company A”; the “feature” is “hard disk”; so as to acquire the relative occurrence frequency.

Next, the extracting means 75 extracts reputation data to be used in the analysis. The analysis focuses on two companies, and compares evaluations for each product of the two companies between the two companies. Therefore, among the reputation data of users on the products by two companies, an extraction is conducted for the subjects of reputation which are stated for the products of two companies.

For example, an assumption is made that the subject of reputation of its own company is set as the “Company A”, and the “Company B” is assigned as a subject of comparison. In this case, the extracting means 75 narrows down reputation data concerning the “Company A” and “Company B” both of which are set to a company either “base” or “subject”, and extracts information on the reputation data (step S203).

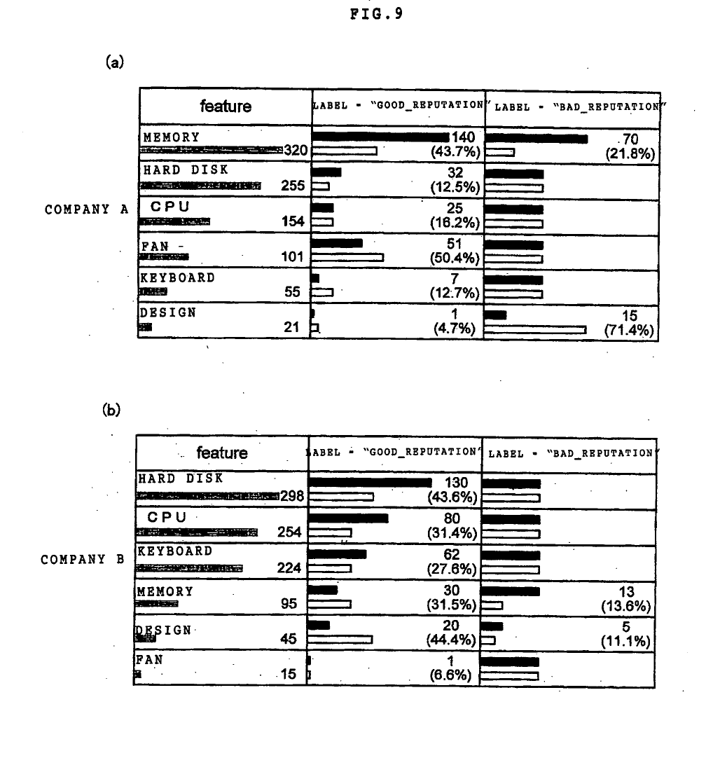

FIG. 9A is a graph showing occurrence frequency and relative occurrence frequency for both “label”s of “good_reputation” and “bad_reputation”, for each “feature”, regarding reputation data in which the “base” is the “Company A”. FIG. 9B is a graph showing occurrence frequency and relative occurrence frequency for the “label” of “good_reputation” and “bad_reputation”, for each “feature”, regarding reputation data in which the “base” is the “Company B”. Note that in each frame a black bar represents occurrence frequency and a white bar represents relative occurrence frequency.

Next, in the analysis, comparison with other competitor companies will be conducted from a viewpoint set forth hereinafter. Specifically, classification to which rank each product defined by the following respective reference criterions will be categorized is obtained, and the classification is used as a third evaluation information. Note that, hereinafter, the “threshold” is a threshold to determine degrees of good_reputation and bad_reputation in the cases of a good reputation and a bad reputation respectively.
(1) a good reputation as a product of the Company A but not at all a good reputation as a product of the Company B

It is unique, and the product should be promoted. Specifically, the product is a product which satisfies that “freq(“Company A”, “Company A”, feat, “good_reputation”)>“freq(“Company B”, “Company B”, feat, “good_reputation”)” and “freq(“Company B”, “Company B”, feat, “good_reputation”)<threshold”.
(2) a good reputation as a product of the Company A but not so good reputation as a product of the Company B

It is a product that has a possibility of competition. Specifically, the product is a product which satisfies that “freq(“Company A”, “Company A”, feat, “good_reputation”)>“freq(“Company B”, “Company B”, feat, “good_reputation”)” and “freq(“Company B”, “Company B”, feat, “good_reputation”)>=threshold”.
(3) a good reputation as a product of the Company B but not so good reputation as a product of the Company A

It is a product that needs to take some measures. Specifically, the product is a product which satisfies that “freq(“Company A”, “Company A”, feat, “good_repytation”)<“freq(“Company B”, “Company B”, feat, “good_repytation”)” and “freq(“Company A”, “Company A”, feat, “good_repytation”)>=threshold”.
(4) a good reputation as a product of the Company B but not at all a good reputation as a product of the Company A

It is a product that needs to be swiftly caught up. Specifically, the product is a product which satisfies that “freq(“Company A”, “Company A”, feat, “good_reputation”)<“freq(“Company B”, “Company B”, feat, “good_reputation”)” and “freq(“Company A”, “Company A”, feat, “good_reputation”)<threshold”.
(5) a bad reputation as a product of the Company A but not at all a bad reputation as a product of the Company B

It is a product that needs to be swiftly taken some measures about. Specifically, the product is a product which satisfies that “freq(“Company A”, “Company A”, feat, “good_reputation”)>“freq(“Company B”, “Company B”, feat, “good_reputation”)”.

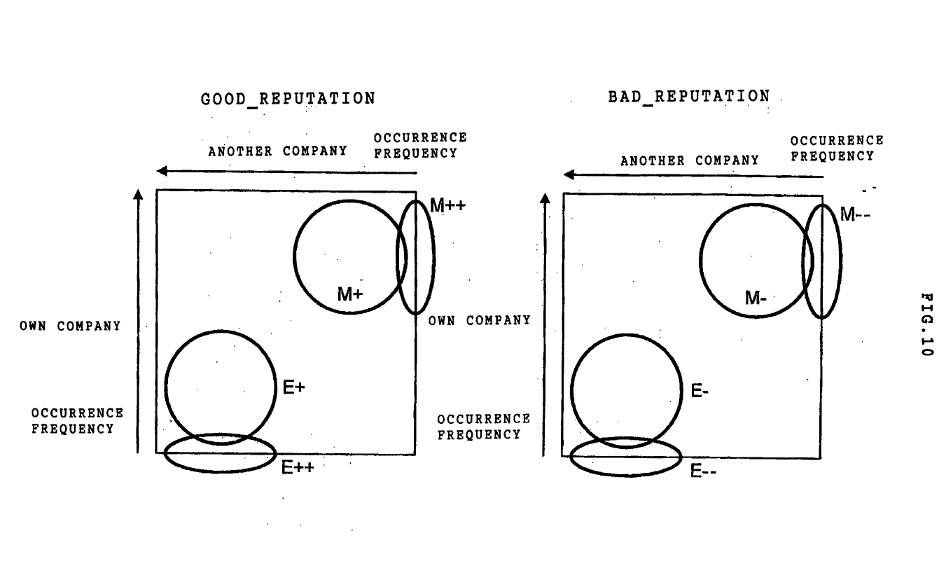

Note that if an attempt is made to make these reference criterions easy to understand, FIG. 10 is what would be obtained.

Here, in reference to a graph of “good_reputation”, the area shown as “M++” corresponds to the rank (1), and “M+” corresponds to the rank (2). Moreover, the area shown as “E+” corresponds to the rank (3), and “E++” corresponds to the rank (4).

Meanwhile, in reference to a graph of “bad_reputation”, the areas shown as “M−−” and “M−” correspond to the rank (5).

This will be specifically observed along the flowchart in FIG. 8. First, the generating means 77 selects one product out of a plurality of products (step S204).

Thereafter, if the selected product is classified into the reference criterion (1), the product is categorized to the rank (1) (step S205). Moreover, if the selected product is classified into the reference criterion (2), the product is categorized to the rank (2) (step S206). Further, if the selected product is classified into the reference criterion (3), the product is categorized to the rank (3) (step S207). Still further, if the selected product is classified into the reference criterion (4), the product is categorized to the rank (4) (step S208). Still further, if the selected product is classified into the reference criterion (5), the product is categorized to the rank (5) (step S209).

Thereafter, the generating means 77 determines whether any products are left for further determination (step S210). If there are some, then move back to step S204, and if there are not then, then the process ends.

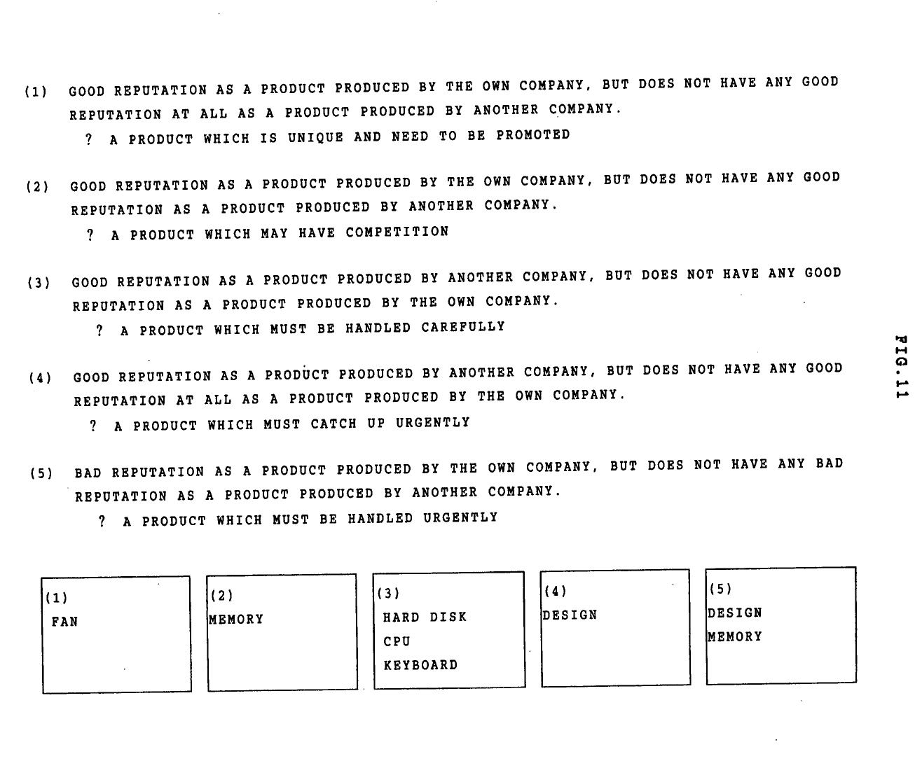

As a result of the processing, evaluation information shown in FIG. 11 is generated. It should be noted that in the specific example, the “Company A” and the “Company B” have gained a particular attention, but in FIG. 11, the expressions, “the own company” and “another company”, are used instead for a more general case. About the evaluation information a specific explanation will be provided using reputation data in FIG. 9. Note that, here, “threshold” is set at “10%”.

First, an explanation is provided on a categorization of ranks using relative occurrence frequency when the “label” is “good_reputation”. As far as a “fan” is concerned, the relative occurrence frequency in the “Company A” is greater than the relative occurrence frequency in the “Company B”, and the relative occurrence frequency in the “Company B” is smaller than the “threshold”. Therefore it is categorized in rank (1). As far as “memory” is concerned, the relative occurrence frequency in the “Company A” is greater than the relative occurrence frequency in the “Company B”, and the relative occurrence frequency in the “Company B” is greater than the “threshold”. Therefore it is categorized in rank (2). As far as “hard disk”, “CPU”, and “keyboard” are concerned, the relative occurrence frequency in the “Company A” is smaller than the relative occurrence frequency in the “Company B”, and the relative occurrence frequency in the “Company A” is greater than the “threshold”. Therefore it is categorized in rank (3). As far as “design” is concerned, the relative occurrence frequency in the “Company A” is smaller than the relative occurrence frequency in the “Company B”, and the relative occurrence frequency in the “Company A” is smaller than the “threshold”. Therefore it is categorized in rank (4).

Next, an explanation is provided on categorization of ranks using relative occurrence frequency when the “label” is “bad_reputation”. As far as “design”, and “memory” are concerned, the relative occurrence frequency in the “Company A” is greater than the relative occurrence frequency in the “Company B”. Therefore it is categorized in rank (5).

As a result of the analysis hereinbefore, it is possible to understand how evaluation for the own company and another company could be different between the two for each product. Therefore, on the basis of comparison with the products of other companies, it becomes possible to take some measures in products development and sales.

It should be noted that, in the foregoing descriptions, the third evaluation information is generated by categorizing products into ranks. However, specific expression methods are not limited to this. For example, it is possible to use a plot of points in a graph of FIG. 10 as third evaluation information. Here, the points in the graph are defined as “freq(“Company A”, “Company A”, feat, “good_reputation”)” along the X-axis (an axis of the own company) and “freq(“Company B”, “Company B”, feat, “good_reputation”)” along the Y-axis (an axis of another company).

Moreover, in the analysis, an analysis is conducted on the basis of reputation data as subjects of analysis. In the reputation data, the same companies are set for each “base” and “subject”. In this case, a reputation on the products of a company by users of the products of the company on which an attention is focused is the only subject of the analysis. However, it is also possible to analyze reputation data as subjects of analysis. Here, in the reputation data, different companies are set for each “base” and “subject”. In that case, it is possible to gather and analyze reputations towards products of the company on which an attention is focused without having any discrimination on the reputation data. In the reputation data, companies of the products used by the users are not particularly identified.

Furthermore, in the analysis, comparisons of reputations on products by each company are conducted focusing on only two companies. However the same comparison may be conducted focusing on three or more companies. In that case, instead of aforementioned reference criterions, a new reference criterion that can compare reputations of products by three or more companies can be set.

Finally, specific effects, which will be brought by the analysis 1 and 2, are described. In other words, if the company images are concerned, a detailed survey can be conducted on the basis of long term hearings and the like. However, in recent years a product life cycle is getting shorter. Under the circumstances, attention is given to the points: how effectively opinions of users are condensed; and how the condensed opinions be lead to differentiation from competitor's products. By use of the methods described in the embodiments, it is possible to use the results of analysis of user's opinions for the competitor analysis, and it is also possible to provide the results in a well-visualized form.

1. An evaluation information generating system comprising:
inputting means for inputting a reputation data set which is composed of reputation data, each indicating a degree of reputation regarding a specific subject, said reputation data set being dividable into a plurality of categories;
counting means for counting an occurrence frequency of reputation data having a predetermined degree of reputation among the reputation data constituting the reputation data set, for each category of the reputation data set inputted by said input means; and
generating means for generating evaluation information on the specific subject by reflecting results of counting attained for the respective categories by said counting means.

2. The evaluation information generating system according to claim 1, wherein said generating means generates information on the results of counting, as evaluation information regarding the specific subject, in categories other than the specific category having a pre-defined relationship with the specific subject.

3. The evaluation information generating system according to claim 2, wherein the specific subject is a specific company and the specific category is a category to which the reputation data belongs, the reputation data being provided by a user of a product by the specific company.

4. The evaluation information generating system according to claim 2, wherein the specific subject is a specific company and the specific category is a category to which the reputation data belongs, the reputation data being data containing a remark on the specific company.

5. The evaluation information generating system according to claim 1, wherein said generating means generates a directed graph, as evaluation information for the specific subject, which shows a result of counting for the specific category by using an arc connecting a first node indicating the specific subject and a second node indicating the specific category.

6. The evaluation information generating system according to claim 5, wherein the specific subject is a specific company; the specific category is a category to which the reputation data belongs, the reputation data being provided by a user of a product by another company other than the specific company; and the arch has a direction from the second node to the first node.

7. The evaluation information generating system according to claim 5, wherein the specific subject is a specific company; the specific category is a category to which the reputation data belongs, the reputation data being data containing a remark on another company other than the specific company; and the arch has a direction from the first node to the second node.

8. The evaluation information generating system according to claim 1, wherein the generating means generates information, as evaluation information for the specific subject, indicating a relative evaluation of a first result of counting in the specific category to a second result of counting in another category other than the specific category.

9. The evaluation information generating system according to claim 8, wherein the generating means generates information, as information indicative of the relative evaluation, indicating a rank to which the specific subject belongs among a plurality of ranks which are defined for a degree of the relative evaluation.

10. The evaluation information generating system according to claim 8, wherein the specific category is a category to which the reputation data belongs, the reputation data being data containing a remark on a product of the specific company, and said another category is a category to which reputation data belongs, the reputation data being data containing a remark on a product of another company other than the specific company.

11. A method of generating evaluation information on a specific subject by using a computer, the method comprising the steps of:
by using the computer, inputting a reputation data set which is composed of reputation data, each indicating a degree of reputation regarding the specific subject, said reputation data set being dividable into a plurality of categories;
by using the computer, counting, for each category of the reputation data set, an occurrence frequency of reputation data having a predetermined degree of reputation among the reputation data constituting the reputation data set, and storing results of counting for the respective categories in a storage device; and
by using the computer, reading the results of counting for the respective categories from the storage device, and generating evaluation information on the specific subject by reflecting the results of counting for the respective categories.

12. The method of generating evaluation information according to claim 11, said generating step further comprising the step of generating information on the results of counting, as evaluation information regarding the specific subject, in categories other than the specific category having a pre-defined relationship with the specific subject.

13. The method of generating evaluation information according to claim 11, said generating step further comprising the step of generating a directed graph, as evaluation information for the specific subject, which shows a result of counting for the specific category by using an arc connecting a first node indicating the specific subject and a second node indicating the specific category.

14. The method of generating evaluation information according to claim 11, said generating step further comprising the step of generating information, as evaluation information for the specific category, indicating a relative evaluation of a first result of counting in the specific category to a second result of counting in another category other than the specific category.

15. A program for causing a computer to implement:
a function of inputting a reputation data set which is composed of reputation data, each indicating a degree of reputation regarding a specific subject, said reputation data set being dividable into a plurality of categories;
a function of counting an occurrence frequency of reputation data having a predetermined degree of reputation among the reputation data constituting the reputation data set, for each category of the reputation data set; and
a function of generating evaluation information on the specific subject while reflecting results of counting for the respective categories.

16. The program product according to claim 15, said generation function further comprising generating of information on the results of counting, as evaluation information regarding the specific subject, in another category other than the specific category having a pre-defined relationship with the specific subject.

17. The program product according to claim 15, said generation function further comprising generating of a directed graph, as evaluation information for the specific subject, which shows a result of counting for the specific category by using an arc connecting a first node indicating the specific subject and a second node indicating the specific category.

18. The program product according to claim 15, wherein said generation function further comprising generating of information indicating a relative evaluation of first results of counting in the specific category against second results of counting in categories other than the specific category.
